(19) United States
(12) Patent Application Publication
(10) Pub. No.: US 2023/0019814 A1
(43) Pub. Date: Jan. 19, 2023

(54) MIGRATION OF VIRTUAL COMPUTE INSTANCES USING REMOTE DIRECT MEMORY ACCESS

(71) Applicant: VMWARE, INC., Palo Alto, CA (US)

(72) Inventors: HALESH SADASHIV, Bangalore (IN); PREETI AGARWAL, San Jose, CA (US); RAJESH VENKATASUBRAMANIAN, San Jose, CA (US)

(21) Appl. No.: 17/460,471

(22) Filed: Aug. 30, 2021

(30) Foreign Application Priority Data
Jul. 14, 2021 (IN) 202141031602

(51) Int. Cl. G06F 9/455; G06F 9/50; G06F 15/173; G06F 12/1009; G06F 11/20

(52) U.S. Cl. CPC G06F 9/45558; G06F 9/5016; G06F 15/17331; G06F 12/1009; G06F 11/2023; G06F 2009/45595; G06F 2009/4557

(57) ABSTRACT

A virtual compute instance is migrated between hosts using remote direct memory access (RDMA). The hosts are equipped with RDMA-enabled network interface controllers for carrying out RDMA operations between them. Upon failure of a first host and copying of page tables of the virtual compute instance to the first host's memory, a first RDMA operation is performed to transfer the page tables from the first host's memory to the second host's memory. Then, second RDMA operations are performed to transfer data pages of the virtual compute instance from the first host's memory to the second host's memory, with references to memory locations of the data pages specified in the page tables. The page tables of the virtual compute instance are reconstructed to reference memory locations of the data pages in the second host's memory and stored therein.

### RELATED APPLICATION

Benefit is claimed under 35 U.S.C. 119(a)-(d) to Foreign Application Serial No. 202141031602 filed in India entitled “MIGRATION OF VIRTUAL COMPUTE INSTANCES USING REMOTE DIRECT MEMORY ACCESS”, on Jul. 14, 2021, by VMware, Inc., which is herein incorporated in its entirety by reference for all purposes.

### BACKGROUND

The ability to migrate running instances of virtual machines (VMs) between host computers is a fundamental advantage of virtual machines over physical machines. Various advancements have been achieved in VM migration technology including live migration, which is described in U.S. Pat. No. 7,484,208. In addition, different forms of VM migration have been practiced. For example, in U.S. Pat. No. 6,795,966, a high availability virtual machine cluster is provided in which a virtual machine is transitioned from one host computer to another host computer using a shared storage system that maintains a representation of the virtual machine state.

The technology described in U.S. Pat. No. 6,795,966 is employed in situations where a host computer has failed and protected VMs running in the failed host computer are recovered in another host. However, failures are often abrupt and result in data loss because there is not sufficient time for the host computers to update the representation of the virtual machine state to the most current state. Consequently, the recovered VMs are restored to an earlier state of the VM, e.g., the most recent checkpointed state, than the current state.

### BRIEF DESCRIPTION OF THE DRAWINGS

FIG. 1 is a block diagram of a computer system that is representative of a virtualized computer architecture in which embodiments may be implemented.

FIG. 2 is a block diagram of a failed host and a failover host of a cluster of hosts for which high availability solution has been enabled, and depicts memory regions of the failed host and the failover host between which RDMA is carried out.

FIG. 3 is a flow diagram that illustrates a method of performing a host failover, according to embodiments.

### DETAILED DESCRIPTION

Embodiments provide an improved technique for migrating VMs (more generally referred to as virtual compute instances) between host computers. This technique employs remote direct memory access (RDMA) to transfer the entire state of a VM residing in system memory of a source host computer to system memory of a destination host computer. Because the technique employs RDMA, the state of the VM in system memory may be transferred even after failure of system software running in the source host computer. As a result, the VM may be recovered on the destination host computer without any data loss even when the system software running in the source host computer crashes.

In the embodiments described below, migration of VMs is described in the context of failover in a high availability virtual machine cluster, where protected VMs running in a failed host computer are recovered in a failover host computer. In such an example, the source host computer is the failed host computer and the destination host computer is the failover host computer, and migration is carried out by suspending the VM in the source host computer and resuming it in the destination host computer. However, embodiments may be practiced in other situations, e.g., in non-high-availability contexts where both the source host computer and the destination host computer are operational.

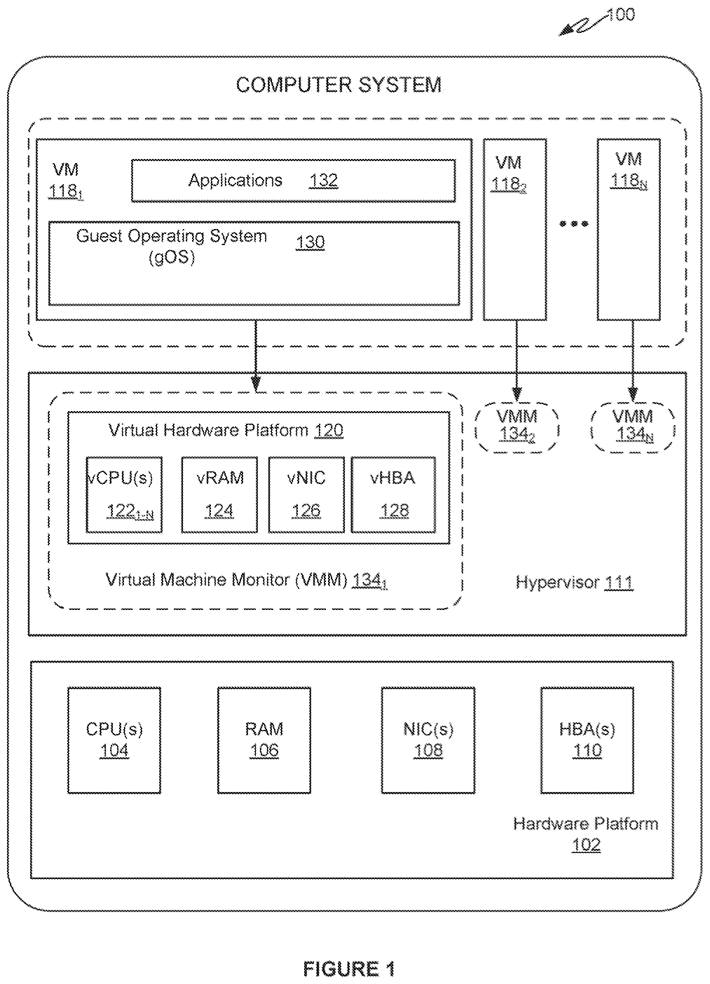

FIG. 1 is a block diagram of a computer system that is representative of a virtualized computer architecture in which embodiments may be implemented. As is illustrated, computer system 100 hosts multiple virtual machines (VMs) 118₁-118_{N} that run on and share a common hardware platform 102. Hardware platform 102 includes conventional computer hardware components, such as one or more items of processing hardware such as central processing units (CPUs) 104, random access memory (RAM) 106 as system memory, one or more network interface controllers (NICs) 108 for connecting to a network, and one or more host bus adapters (HBAs) 110 for connecting to a storage system.

In the embodiments, NICs 108 include functionality to support RDMA transport protocols, e.g., RDMA over Converged Ethernet (RoCE) and Wide Area RDMA Protocol (iWARP), in addition to other transport protocols, such as TCP. Such RDMA-enabled NICs are commercially available from hardware vendors, such as Mellanox Technologies, Inc. and Chelsio Communications.

A virtualization software layer, referred to hereinafter as hypervisor 111, is installed on top of hardware platform 102. Hypervisor 111 makes possible the concurrent instantiation and execution of one or more VMs 118₁-118_{N}. The interaction of a VM 118 with hypervisor 111 is facilitated by the virtual machine monitors (VMMs) 134. Each VMM 134₁-134_{N} is assigned to and monitors a corresponding VM 118₁-118_{N}. In one embodiment, hypervisor 111 may be a hypervisor implemented as a commercial product in VMware's vSphere® virtualization product, available from VMware Inc. of Palo Alto, Calif. In an alternative embodiment, hypervisor 111 runs on top of a host operating system which itself runs on hardware platform 102. In such an embodiment, hypervisor 111 operates above an abstraction level provided by the host operating system.

After instantiation, each VM 118₁-118_{N} encapsulates a virtual hardware platform that is executed under the control of hypervisor 111, in particular the corresponding VMM 134₁-134_{N}. For example, virtual hardware devices of VM 118₁ in virtual hardware platform 120 include one or more virtual CPUs (vCPUs) 122₁-122_{N}, a virtual random access memory (vRAM) 124, a virtual network interface adapter (vNIC) 126, and virtual HBA (vHBA) 128. Virtual hardware platform 120 supports the installation of a guest operating system (guest OS) 130, on top of which applications 132 are executed in VM 1181. Examples of guest OS 130 include any of the well-known commodity operating systems, such as the Microsoft Windows® operating system, the Linux® operating system, and the like.

It should be recognized that the various terms, layers, and categorizations used to describe the components in FIG. 1 may be referred to differently without departing from their functionality or the spirit or scope of the disclosure. For example, VMMs 1341-134N may be considered separate virtualization components between VMs 1181-118N and hypervisor 111 since there exists a separate VMM for each instantiated VM. Alternatively, each VMM may be considered to be a component of its corresponding virtual machine since each VMM includes the hardware emulation components for the virtual machine.

In the embodiments, a plurality of host computers (also referred to simply as “hosts”), each configured in the manner illustrated for computer system 100, is managed as a cluster by a VM management server 210 to provide cluster-level functions, such as load balancing across the cluster by performing VM migration between the hosts, distributed power management, dynamic VM placement according to affinity and anti-affinity rules, and high availability (HA). VM management server 210 also manages shared storage 220 to provision storage resources for the cluster.

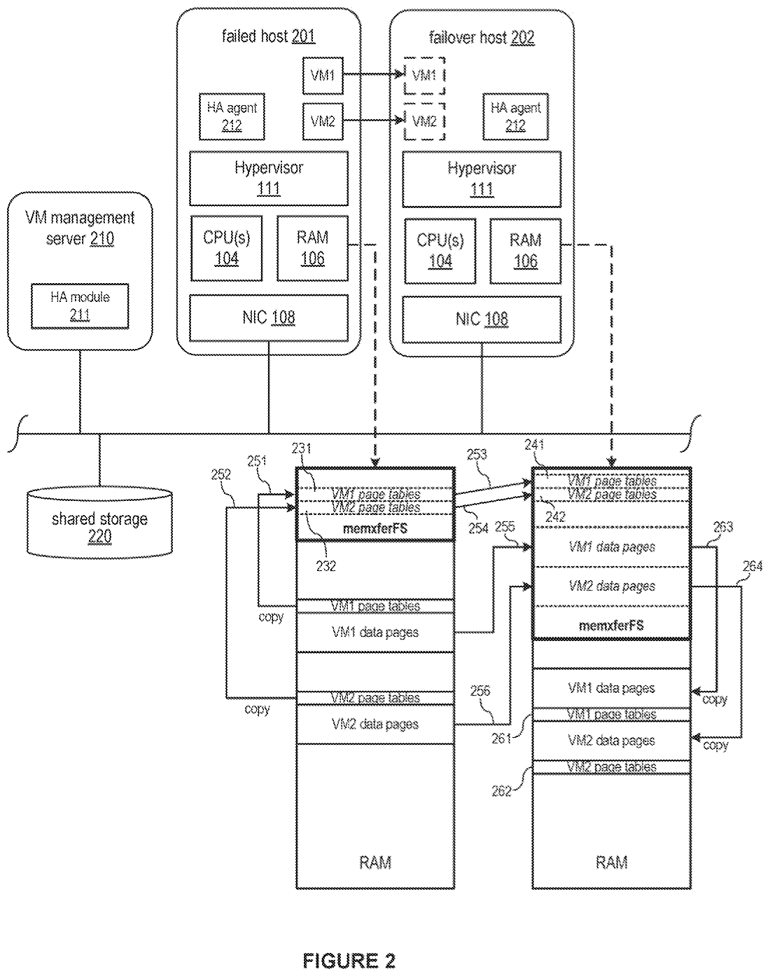

FIG. 2 is a block diagram of a failed host 201 and a failover host 202 of a cluster of hosts for which high availability solution has been enabled, and depicts memory regions of the failed host and the failover host between which RDMA is carried out. As depicted, VM management server 210, which is a physical or virtual server, includes an HA module 211 that communicates with HA agents 212 installed in the hosts of the cluster to implement the HA solution.

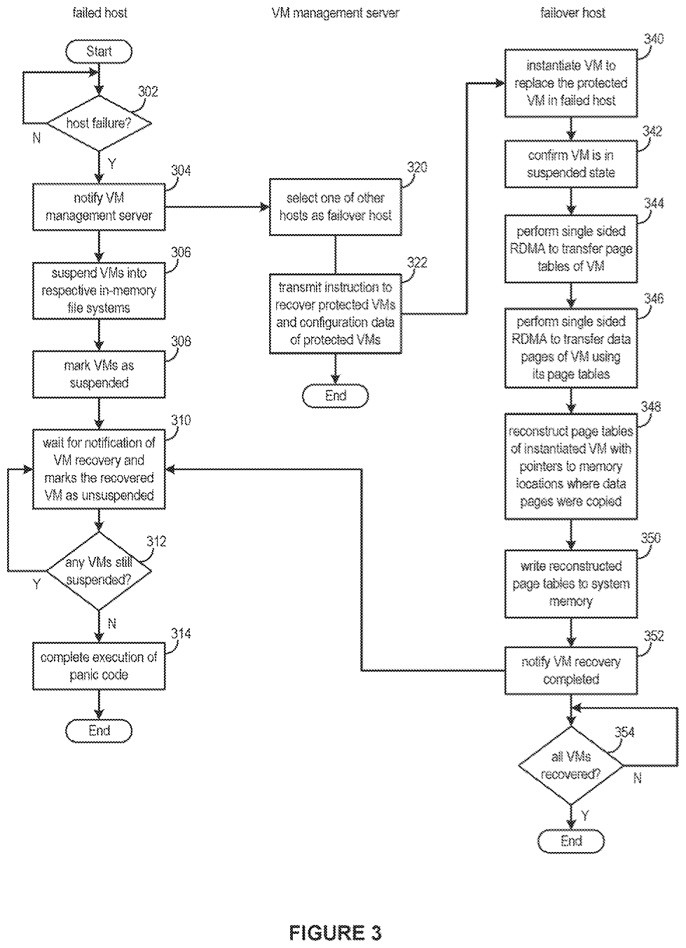

Failed host 201 represents a host that has failed, e.g., as a result of system software (e.g., hypervisor 111) crash. Failover host 202 represents a host in which protected VMs (which are VMs designated for high availability and depicted in FIG. 2 as VM1 and VM2) are recovered. The method of performing a host failover including recovery of protected VMs in failover host 202 is illustrated in FIG. 3 and described below.

In the embodiments, RDMA-enabled NICs transfer data directly between system memory of hosts without involving the system software of either host. In general, RDMA implementations provide several communication primitives (so called “verbs”) that can be categorized into the following two classes: (1) one-sided and (2) two-sided verbs. One-sided RDMA verbs (READ/WRITE) provide remote memory access semantics, in which the host (which is the failover host in the embodiments) specifies the memory address of the remote node (which is the failed host in the embodiments) that should be accessed. When using one-sided verbs, the CPU of the remote node is not actively involved in the data transfer. Two-sided verbs (SEND/RECEIVE) provide channel semantics. In order to transfer data between a host and a remote node, the remote node first needs to publish a RECEIVE request before the host can transfer the data with a SEND operation. In contrast to one-sided verbs, the host does not specify the target remote memory address. Instead, the remote host defines the target address in its RECEIVE operation. Consequently, by posting the RECEIVE, the remote CPU is actively involved in the data transfer.

Embodiments employ one-sided RDMA verbs, in particular one-sided RDMA READ, hereinafter referred to as a single-sided RDMA operation. To do so, a memory transfer region is configured in each host when the host is booted up. This memory transfer region has a fixed virtual address space, such that the mapping between the virtual addresses and the physical addresses in this memory transfer region are fixed. When VMs are powered-on (i.e., instantiated), hypervisor 111 creates an in-memory file system for each of the VMs in this memory transfer region, and communicates with other hosts in the cluster to create RDMA queue pairs. An RDMA queue pair includes a send queue and a receive queue. The send queue includes a pointer to a memory region from which data are sent and the receive queue includes a pointer to a memory region into which data will be received. For example, when a VM is instantiated in a host, a pointer to the in-memory file system that the hypervisor created for the VM and from which data will be sent will be placed in the send queue, and in each of the other hosts in the cluster, a pointer to the memory region for receiving the data will be placed in the receive queue. Accordingly, multiple queue pairs are created in the cluster each time a VM is instantiated.

In FIG. 2, the memory transfer regions of host 201 and host 202 are labeled “memxferFS.” In the system memory of host 201, the in-memory file system for VM1 is created in memory region 231 and the in-memory file system for VM2 is created in memory region 232. In addition, the memory region that the hypervisor of host 202 created in the memory transfer region for receiving the data of memory region 231 is depicted as memory region 241 and the memory region that the hypervisor of host 202 created in the memory transfer region for receiving the data of memory region 232 is depicted as memory region 242.

When host 201 fails (e.g., as a result of crash of hypervisor 111), host 201 executes a panic code to suspend the protected VMs of host 201, e.g., VM1 and VM2, and copy page tables of the protected VMs into their respective in-memory file systems. The copying of the VM1 pages tables into memory region 231 is depicted with an arrow 251 and the copying of the VM2 pages tables into memory region 232 is depicted with an arrow 252. After the page tables have been copied into memory regions 231, 232, NIC 108 of host 202, which represents the failover host, performs a single-sided RDMA read operation with reference to the established queue pairs to transfer the contents of memory region 231 into memory region 241 (as depicted by arrow 253) without involving the CPU of host 201 and to transfer the contents of memory region 232 into memory region 242 (as depicted by arrow 254) without involving the CPU of host 201. As a result, the VM1 page tables and the VM2 pages tables are now resident in memory regions of host 202.

After the page tables have been copied over, NIC 108 of host 202 performs additional single-sided RDMA read operations to transfer data pages of VM1 and VM2 from their locations in system memory of host 201 to the memory transfer region of host 202 as depicted by arrows 255 and 256. The single-sided RDMA read operations specify the locations of the data pages of VM1 in the system memory of host 201 determined from the VM1 page tables transferred into memory region 241 and the locations of the data pages of VM2 in the system memory of host 201 determined from the VM2 page tables transferred into memory region 242. After all contents of the data pages of VM1 have been transferred into the memory transfer region of host 202, the hypervisor of host 202 copies them into new locations in system memory of host 202 as depicted by arrow 263, and reconstructs the page tables of VM1 to reference the new locations in system memory of host 202 into which the data pages of VM1 have been copied. The reconstructed page tables of VM1 are then written to memory region 261. Similarly, after all contents of the data pages of VM2 have been transferred into the memory transfer region of host 202, the hypervisor of host 202 copies them into new locations in system memory of host 202 as depicted by arrow 264, and reconstructs the page tables of VM2 to reference new locations in system memory of host 202 into which the data pages of VM2 have been copied. The reconstructed page tables of VM2 are then written to memory region 262.

FIG. 3 is a flow diagram that illustrates a method of performing a host failover, according to embodiments. At step 302, the HA agent monitors for host failure, which may be, e.g., a crash of the hypervisor. Upon determining that a host has failed, the HA agent of the failed host notifies the VM management server at step 304. After notifying the VM management server, the failed host begins execution of the panic code. At step 306, the failed host suspends the protected VMs, which includes copying of the page tables of the protected VMs into their respective in-memory file systems that were created in the memory transfer region of the failed host when the protected VMs were powered-on. The progress of the VM suspension is tracked in a data structure stored in the system memory of the failed host. Once suspension has completed, the failed host at step 308 marks the protected VM as suspended. After all VMs have been suspended, the failed host at step 310 waits for notification that a protected VM has been recovered at the failover host and, upon receiving the notification, marks the suspended VM that has been recovered as unsuspended. The failed host at step 312 determines if any protected VM is still in a suspended state. If so, step 310 is repeated. If not, the failed host at 314, completes execution of the panic code.

In response to the notification sent by the failed host at step 304, the VM management server at step 320, selects one of the other hosts of the cluster as a failover host, i.e., the host in which the protected VMs in the failed host are to be recovered. At step 322, the VM management server instructs the failover host to recover the protected VMs and transmits the configuration data of the protected VMs in the failed host to the failover host. The configuration data provides identifying information for the protected VMs and the storage provisioned for the protected VMs in shared storage 220, and also specifies resource requirements for the protected VMs.

Upon receipt of instruction to recover the protected VMs, the failover host executes steps 340, 342, 344, 346, 348, 350, 352, and 354 for each of the protected VMs. At step 340, the failover host instantiates the protected VMs using the configuration data provided by the VM management server. Then, at step 342, the failover host confirms that the protected VM has been suspended (e.g., by performing a single-sided RDMA read operation on the data structure in the system memory of the failed host that tracks the suspended state of the protected VMs). After confirming that the protected VM has been suspended, the failover host at step 344 performs a single-sided RDMA read operation with reference to the established queue pairs to transfer the page tables of the protected VM from the memory transfer region of the failed host to the memory transfer region of the failover host, without involving the CPU of the failed host. After the page tables have been copied over, the failover host at step 346 performs additional single-sided RDMA read operations to transfer data pages of the protected VM from the system memory of the failed host to its memory transfer region and then copies the transferred data pages into free locations in its system memory. After all contents of the data pages of the protected VM have been transferred and copied into new locations in its system memory, the failover host at step 348 reconstructs the page tables of the protected VM to reference the new locations in the system memory thereof into which the data pages of the protected VM have been copied, and at step 350 writes the reconstructed page tables to the system memory thereof. Then, at step 352, the failover host notifies the failed host that the protected VM has been recovered. The process on the failover host side ends when all protected VMs have been recovered (step 354; Yes).

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O.

Certain embodiments may be implemented in a host computer without a hardware abstraction layer or an OS-less container. For example, certain embodiments may be implemented in a host computer running a Linux® or Windows® operating system.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system. Computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs) —CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of migrating a virtual compute instance from a first host computer to a second host computer using remote direct memory access (RDMA), the first host computer including a first network interface controller (NIC) and a first system memory having a first memory region allocated for memory transfer, and the second host computer including a second NIC and a second system memory having a second memory region allocated for memory transfer, the method comprising:
upon failure of the first host computer and copying of page tables of the virtual compute instance to the first memory region, performing a first RDMA operation to transfer the page tables of the virtual compute instance from the first memory region to the second memory region;
performing second RDMA operations to transfer data pages of the virtual compute instance from the first system memory to the second system memory, with references to memory locations of the data pages in the first system memory specified in the page tables; and
reconstructing the page tables of the virtual compute instance to reference memory locations of the data pages in the second system memory and writing the reconstructed page tables to the second system memory.

2. The method of claim 1, wherein
the first NIC maintains a send queue into which a first pointer to the first memory region is added and the second NIC maintains a receive queue into which a second pointer to the second memory region is added, and the first RDMA operation is performed at the first host computer by the first NIC with reference to the first pointer added to the send queue and at the second host computer by the second NIC with reference to the second pointer added to the receive queue.

3. The method of claim 2, wherein
the second RDMA operations are performed at the first host computer by the first NIC to transmit the data pages from memory locations thereof specified in the page tables, and at the second host computer by the second NIC to store the transmitted data pages to new memory locations in the second system memory.

4. The method of claim 1, wherein the first memory region is a fixed virtual address space created during booting of the first host computer and the second memory region is a fixed virtual address space created during booting of the second host computer.

5. The method of claim 4, wherein the first and second pointers are established when the virtual compute instance is instantiated in the first host computer.

6. The method of claim 1, wherein the first and second host computers are host computers of a cluster of host computers for which a high availability solution has been enabled for selected virtual machines running therein, and the virtual compute instance is a virtual machine for which the high availability solution has been enabled.

7. The method of claim 6, wherein
upon failure of the first host computer, the second host computer is selected from the cluster of host computers as a failover host computer for the first host computer, and
the virtual machine is recovered in the second host computer from the transferred page tables and the transferred data pages.

8. A non-transitory computer-readable medium comprising instructions that are executed on a processor to carry out a method of migrating a virtual compute instance from a first host computer to a second host computer using remote direct memory access (RDMA), the first host computer including a first network interface controller (NIC) and a first system memory having a first memory region allocated for memory transfer, and the second host computer including a second NIC and a second system memory having a second memory region allocated for memory transfer, said method comprising:
upon failure of the first host computer and copying of page tables of the virtual compute instance to the first memory region, performing a first RDMA operation to transfer the page tables of the virtual compute instance from the first memory region to the second memory region;
performing second RDMA operations to transfer data pages of the virtual compute instance from the first system memory to the second system memory, with references to memory locations of the data pages in the first system memory specified in the page tables; and
reconstructing the page tables of the virtual compute instance to reference memory locations of the data pages in the second system memory and writing the reconstructed page tables to the second system memory.

9. The non-transitory computer readable medium of claim 8, wherein
the first NIC maintains a send queue into which a first pointer to the first memory region is added and the second NIC maintains a receive queue into which a second pointer to the second memory region is added, and the first RDMA operation is performed at the first host computer by the first NIC with reference to the first pointer added to the send queue and at the second host computer by the second NIC with reference to the second pointer added to the receive queue.

10. The non-transitory computer readable medium of claim 9, wherein
the second RDMA operations are performed at the first host computer by the first NIC to transmit the data pages from memory locations thereof specified in the page tables, and at the second host computer by the second NIC to store the transmitted data pages to new memory locations in the second system memory.

11. The non-transitory computer readable medium of claim 8, wherein the first memory region is a fixed virtual address space created during booting of the first host computer and the second memory region is a fixed virtual address space created during booting of the second host computer.

12. The non-transitory computer readable medium of claim 11, wherein the first and second pointers are established when the virtual compute instance is instantiated in the first host computer.

13. The non-transitory computer readable medium of claim 8, wherein the first and second host computers are host computers of a cluster of host computers for which a high availability solution has been enabled for selected virtual machines running therein, and the virtual compute instance is a virtual machine for which the high availability solution has been enabled.

14. The non-transitory computer readable medium of claim 13, wherein
upon failure of the first host computer, the second host computer is selected from the cluster of host computers as a failover host computer for the first host computer, and
the virtual machine is recovered in the second host computer from the transferred page tables and the transferred data pages.

15. A computer system comprising:
a plurality of host computers, in each of which virtualization software is executed to support an execution space for virtual compute instances;
a virtual machine management server communicating with the host computers to power-on and power-off virtual compute instances in the host computers and to migrate virtual compute instances between the host computers using remote direct memory access (RDMA), wherein
the host computers include a first host computer including a first network interface controller (NIC) and a first system memory having a first memory region allocated for memory transfer, and a second host computer including a second NIC and a second system memory having a second memory region allocated for memory transfer, and
the second host computer is programmed to:
upon failure of the first host computer and copying of page tables of a virtual compute instance running in the first host computer to the first memory region, performing a first RDMA operation to transfer the page tables of the virtual compute instance from the first memory region to the second memory region;
performing second RDMA operations to transfer data pages of the virtual compute instance from the first system memory to the second system memory, with references to memory locations of the data pages in the first system memory specified in the page tables; and
reconstructing the page tables of the virtual compute instance to reference memory locations of the data pages in the second system memory and writing the reconstructed page tables to the second system memory.

16. The computer system of claim 15, wherein
the first NIC maintains a send queue into which a first pointer to the first memory region is added and the second NIC maintains a receive queue into which a second pointer to the second memory region is added, and the first RDMA operation is performed at the first host computer by the first NIC with reference to the first pointer added to the send queue and at the second host computer by the second NIC with reference to the second pointer added to the receive queue.

17. The computer system of claim 16, wherein
the second RDMA operations are performed at the first host computer by the first NIC to transmit the data pages from memory locations thereof specified in the page tables, and at the second host computer by the second NIC to store the transmitted data pages to new memory locations in the second system memory.

18. The computer system of claim 15, wherein the first memory region is a fixed virtual address space created during booting of the first host computer and the second memory region is a fixed virtual address space created during booting of the second host computer.

19. The computer system of claim 18, wherein the first and second pointers are established when the virtual compute instance is instantiated in the first host computer.

20. The computer system of claim 15, wherein the virtual compute instance is a virtual machine and the virtual machine management server selected the second host computer as a failover host computer for the first host computer.
